(19) United States
(12) Patent Application Publication
(10) Pub. No.: US 2005/0127827 A1
(43) Pub. Date: Jun. 16, 2005

(54) Organic light-emitting device

(75) Inventors: Mizuho Hiraoka, Kanagawa (JP); Hiroshi Tanabe, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/991,372

(22) Filed: Nov. 19, 2004

(30) Foreign Application Priority Data
Dec. 15, 2003 (JP) 2003-416160

(51) Int. Cl. H05B 33/12

(52) U.S. Cl. 313/504; 313/506; 428/690; 428/917

(57) ABSTRACT

The present invention provides a practical organic light-emitting device which shows no attenuation of emission luminance even when driven for a long period of time and which is excellent in durability. The organic light-emitting device of the present invention is an organic light-emitting device including an organic compound layer having at least an organic luminescent layer, the organic compound layer being sandwiched between a pair of electrodes composed of an anode and a cathode, in which at least one of the organic compounds used for forming the organic compound layer has a purity of 99 mol % or more in analysis according to a differential scanning calorimetry method.

### BACKGROUND OF THE INVENTION

1. Field of the Invention

The present invention relates to an organic light-emitting device including an organic compound layer having at least an organic luminescent layer, the organic compound layer being sandwiched between a pair of electrodes composed of an anode and a cathode.

2. Related Background Art

Light-emitting devices utilizing electroluminescence have high visibility because they emit light by themselves. In addition, the devices are complete solid state devices. Thus, the devices have characteristics such as excellent impact resistance. Therefore, attention has been focused on the use of the devices as light-emitting devices in various display apparatuses.

Those light-emitting devices are classified into inorganic light-emitting device obtained by using inorganic compounds as luminescent materials and organic light-emitting devices obtained by using organic compounds as luminescent materials. In particular, the organic light-emitting devices can significantly reduce applied voltages, can be easily downsized, require small power consumptions, enable surface emission, and facilitate light emission of three primary colors. Therefore, research for putting the organic light-emitting devices into practical use as new-generation light-emitting devices has been vigorously conducted.

An organic light-emitting device has a basic configuration of anode/organic luminescent layer/cathode. There have been also known configurations obtained by appropriately arranging a hole-injecting-transporting layer and an electron-injecting layer on the basic configuration such as a configuration of anode/hole-injecting-transporting layer/organic luminescent layer/cathode and a configuration of anode/hole-injecting-transporting layer/organic luminescent layer/electron-injecting layer/cathode.

The largest object in the research for putting such an organic light-emitting devices into practical use is to establish a technique with which the attenuation of emission luminance of the organic light-emitting device when driven for a long period of time is suppressed to enable the device to be put into practical use. One possible approach for establishing such a technique is to increase the purity of each of various organic compounds used for forming an organic light-emitting device. An increase in impurity is expected to suppress the attenuation of luminous efficiency or of emission luminance. A general purity measurement method involves determining the purity from an area ratio of data according to a high-performance liquid chromatography method (HPLC method).

Techniques related to purity measurement of an organic compound layer in an organic light-emitting device are shown by, for example, Japanese Patent Application Laid-Open Nos. 2001-214159 and 2002-175885. Those publications each disclose that the HPLC method is used to measure the purity of an organic compound.

However, no clear correlation between the purity determined from the area ratio of data according to the HPLC method and the durability of the device was found. In particular, a high purity of 95% or more in the HPLC method had no correlation with the durability of an organic light-emitting device even if the purity was merely increased. Thus, there are a large number of uncertainties about the correlation between them. Therefore, the detail about the reason why the emission luminance of an organic light-emitting device attenuates when the device is used for a long period of time is currently unclear so that some practical indicators for the reason have been demanded.

The HPLC method has been widely known as a method of measuring the purity of an organic substance. However, in a chromatography method such as the HPLC method, impurities such as a by-product and a catalyst are detected, but a purity higher than an actual value is obtained in spite of the fact that insoluble matter into a solvent layer, a volatile component, water, and the like actually remain as impurities. This is because the insoluble matter into the solvent layer is removed through filtration before chromatography and the volatile component and water are generally measured under the conditions under which they are not detected according to a chromatography method. In particular, an organic compound forming an organic luminescent layer tends to contain a solvent as an impurity. In some cases, the organic compound contains 10 and several percents or less of solvent at a temperature before the melting point of the organic compound. In addition, measurement according to TGMS carried out by the inventors of the present invention has shown that the evaporation of the solvent as an impurity occurs even around the melting point of the organic compound. However, there has been a problem in that such a solvent as an impurity cannot be detected according to the HPLC method.

### SUMMARY OF THE INVENTION

The present invention has been made in view of the above problems, and an object of the present invention is to provide a practical organic light-emitting device which shows no attenuation of emission luminance even when driven for a long period of time and which is excellent in durability.

To achieve the above object, the organic light-emitting device of the present invention is characterized by including an organic compound layer having at least an organic luminescent layer, the organic compound layer being sandwiched between a pair of electrodes composed of an anode and a cathode, in which at least one of the organic compounds used for forming the organic compound layer is an organic compound having a purity of 99 mol % or more in analysis according to a differential scanning calorimetry method (DSC method).

In the organic light-emitting device, the organic compound having a purity of 99 mol % or more is preferably purified by means of a sublimation purification method.

In the organic light-emitting device, the respective layers of the organic compounds constituting the organic compound layer are preferably formed by means of a physical vapor deposition method (PVD method).

According to the present invention, there is provided a practical organic light-emitting device which shows no attenuation of emission luminance even when driven for a long period of time and which is excellent in durability.

### BRIEF DESCRIPTION OF THE DRAWINGS

FIG. 1 is a schematic view showing an example of a layer configuration of an organic light-emitting device according to the present invention;

FIG. 2 is an explanatory graph showing a melting curve for purity determination;

FIG. 3 is an explanatory graph showing a method of determining a solidification point T_{f} of a sample and a melting point T₁* of a pure sample; and

FIG. 4 is an explanatory graph showing a DSC curve obtained by stepwise temperature rise.

### DESCRIPTION OF THE PREFERRED EMBODIMENTS

Hereinafter, the best embodiment for carrying out the present invention will be described with reference to the drawings. However, the present invention is not limited to this embodiment.

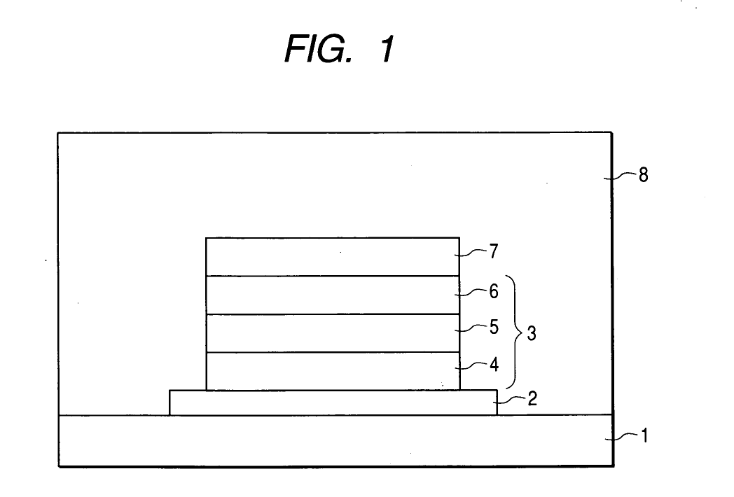

First, the reference numerals in FIG. 1 will be described.

Reference numeral 1 denotes a substrate; 2, an anode; 3, an organic compound layer; 4, a hole-transporting layer; 5, an organic luminescent layer; 6, an electron-transporting layer; 7, a cathode (transparent electrode); and 8, a casing.

FIG. 1 is a schematic view showing an example of an organic light-emitting device according to the present invention. As shown in FIG. 1, the organic light-emitting device according to the present invention is obtained by sandwiching the organic compound layer 3 having at least the organic luminescent layer 5 between a pair of electrodes composed of the anode 2 formed on the substrate 1 and the cathode 7. For example, the organic compound layer 3 has a layer configuration of the anode 2/the hole-transporting layer 4/the organic luminescent layer 5/the electron-transporting layer 6/the cathode 7. However, the organic compound layer is not limited to such a layer configuration. The organic light-emitting device is covered with the casing 8 such as a cover glass plate for protection and sealed with an acrylic resin-based adhesive or the like in a dry air atmosphere in order to avoid device deterioration due to adsorption of moisture.

In the organic light-emitting device of this embodiment, at least one of the organic compounds used for forming the organic compound layer 3 must have a purity of 99 mol % or more in analysis according to a differential scanning calorimetry method (DSC method). This is because an organic compound layer formed of organic compounds each having a purity of less than 99 mol % cannot provide an organic light-emitting device having desired durability. The phrase “at least one of the organic compounds used for forming the organic compound layer 3” refers to one or two or more of the organic compounds constituting, for example, the luminescent layer (a single light-emitting substance or a combination of a dopant and a host compound)/the hole-injecting-transporting layer (the hole-injecting layer and the hole-transporting layer)/the electron-injecting-transporting layer (the electron-injecting layer and the electron-transporting layer).

As described above, in purity measurement according to the HPLC method that has been conventionally used, a solvent as an impurity cannot be detected. However, in purity measurement according to the DSC method, the impurity amount can be grasped when the DSC method is used in combination with thermogravimetry-differential thermal analysis (TG-DTA). The solvent as an impurity may be strongly bound to an organic compound constituting the organic luminescent layer of the organic light-emitting device. In some cases, the solvent as an impurity can be removed by using a thermal purification method involving heating at a temperature around the melting point of the organic compound.

In the purity measurement according to the DSC method, an individual impurity cannot be specified, but the total amount of impurities (mol %) can be accurately determined. In addition, an impurity that gasifies at a temperature around the melting point of an organic compound forming the organic luminescent layer can be specified by using the TGMS method.

In this embodiment, a DSC Pyris1 manufactured by PerkinElmer, Inc. is used as a purity measuring apparatus according to the DSC method.

Examples of a method for the purity measurement according to the DSC method include methods described in “Technical System for Higher Purity”: “thermal analysis and purity determination for heat absorption/generation” of the second section of the chapter 21 “Thermal Analysis Method” of vol. 1 Analysis Technique, and in “Basis and Application of Thermal Analysis”: “purity evaluation according to DSC” of third edition 2.17. To be specific, a dynamic method and a stepwise method are exemplified.

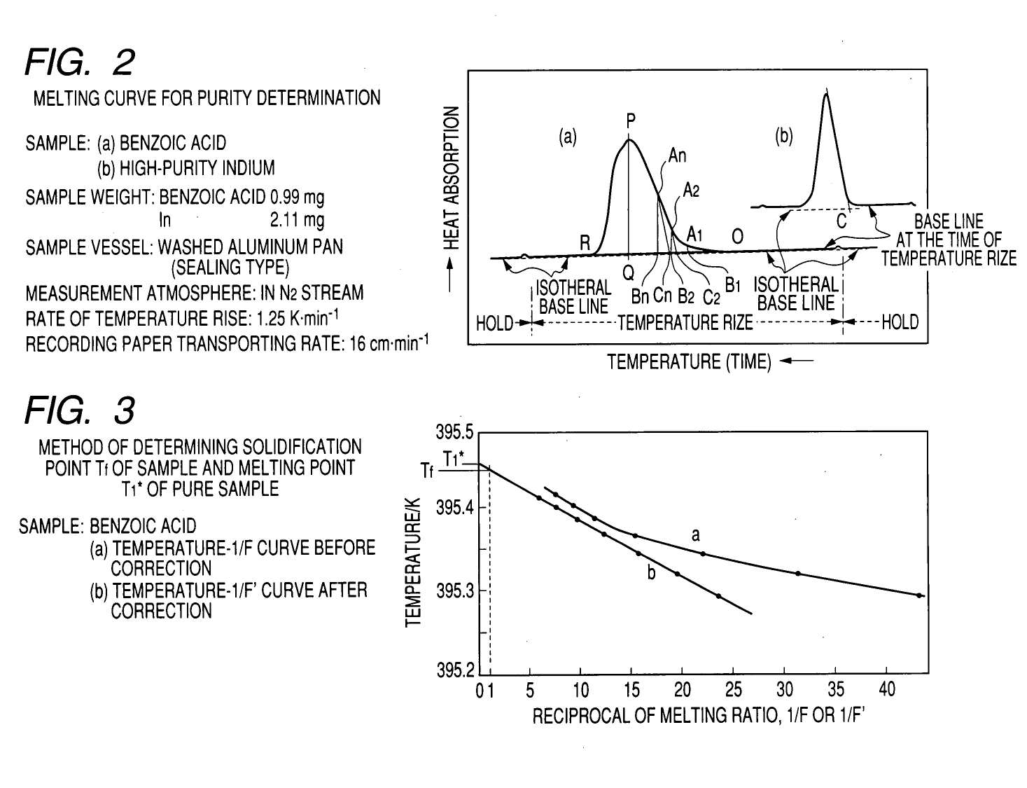

First, the dynamic method will be described with reference to FIG. 2 and FIG. 3. FIG. 2 is an explanatory graph showing a melting curve for purity determination, whereas FIG. 3 is an explanatory graph showing a method of determining a solidification point T_{f} of a sample and a melting point T₁* of a pure sample.

Sample Preparation

Sample vessels that have been sufficiently washed and dried are used. After it is confirmed that the bottom of each sample vessel is flat, a sample is placed in one sample vessel and the one sample vessel is sealed, while the other sample vessel is sealed without placing a sample in it. Each of the sample vessels is set in a sample holder and subjected to nitrogen purge.

Measurement

The sample is heated at a temperature rise rate as small as possible, for example, 1° C./min. After the completion of melting of the sample, the sample is heated until a base line is drawn. In addition, the melting peak of a high-purity metal sample having a melting point as close to the melting temperature of the above sample as possible is measured according to the same procedure.

Analysis

(1) A point O at which the DSC curve of (a) shown in FIG. 2 starts to deviate from the base line at the time of temperature rise is defined as a melting starting point, and a point at which the curve returns to the base line again is denoted by R. An area surrounded by the base line at the time of temperature rise and the melting curve corresponds to the heat of melting of the sample. A perpendicular AₙBₙ is drawn from a point Aₙ at a height about a half of the height PQ of the peak to the base line at the time of temperature rise. In addition, perpendiculars are drawn between the point O and the point Bₙ at appropriate intervals to divide the line segment OBₙ into 6 or more sections, preferably slightly larger than 10 sections. The intersection points of the perpendiculars drawn between the point O and the point Bₙ and the melting curve are denoted by A₁, A₂, . . . , Aₙ₋₁. Meanwhile, the intersection points of the perpendiculars drawn between the point O and the point Bₙ and the base line at the time of temperature rise are denoted by B₁, B₂, . . . , Bₙ₋₁.

(2) A tangent is drawn to a linear portion having the maximum gradient including an inflection point on the curve on the rise-up side (melting process) of the melting peak of (b) shown in FIG. 2. The tangent is parallelly displaced, and a straight line having the same gradient as that of the tangent is drawn from each of the points A₁, A₂, . . . , Aₙ of (a) shown in FIG. 2. The intersection points of those straight lines each having the same gradient as that of the tangent and the isothermal base line represented by a broken line are denoted by C₁, C₂, . . . , Cₙ. Temperatures read from the points C₁, C₂, Cₙ are denoted by T₁, T₂, . . . , Tₙ. Each of those temperatures is a temperature of the sample at which a pen of a recorder starts to draw a melting curve at the point A₁, A₂, . . . , Aₙ. The quantity of heat absorbed by the sample from the beginning of melting at the temperature Tₙ corresponds to the area surrounded by the isothermal base line, the melting curve, and the perpendicular AₙBₙ.

(3) The area of the melting peak of the sample is denoted by at and the areas surrounded by the base line at the time of temperature rise, the melting curve, and the perpendiculars A₁B₁, A₂B₂, . . . , AₙBₙ are denoted by a₁, a₂, . . . , aₙ. The melting ratio F of the sample at each of the points A₁, A₂, . . . , Aₙ is given by F₁=a₁/aₜ, F₂=a₂/aₜ, . . . , Fₙ, =aₙ/aₜ. Those areas can be calculated by using an analytic soft of the Pyris1. Those areas can also be determined by: drawing a chart on chart paper; copying the chart; cutting out the chart; and weighing the chart while conditioning moisture.

(4) A graph is drawn, in which the axis of abscissa indicates the reciprocal of the melting ratio F of the sample and the axis of ordinate indicates the sample temperature T for the melting ratio F. An upward concave curve like the curve a shown in FIG. 3 is frequently obtained.

(5) Correction of melting ratio: A point at which the value of F is larger than 0.02 but is as small as possible is selected, and the sample temperature and the quantity of heat absorbed at the point are denoted by T1 and a1, respectively. A point with a large value of F (III) and a point with an intermediate value of F (II) are selected, and TIII, aIII, TII, and aII are similarly determined. Those values are substituted into the following equation (1) to determine the value for q.

$$q = \frac{\frac{TIII - TII}{TII - T 1} aIII - \frac{aIII - aII}{aII - a 1} a 1}{\frac{aIII - aII}{aII - a 1} - \frac{TIII - TII}{TII - T 1}} \qquad ( 1 )$$

(6) Corrected melting ratios F₁′, =(a₁+q)/(aₜ+q), F₂′=(a₂+q)/(aₜ+q), . . . , and Fₙ′=(aₙ+q)/(aₜ+q) are calculated by using the value for q thus obtained. The correction is correction for heat that cannot be detected.

(7) A T versus 1/F′ graph (b shown in FIG. 3) is drawn, and T_{f} is determined from 1/F′=1 and T₁* is determined from 1/F′=0 on the straight line (the tangent at the inflection point in the case of an S-shaped curve). Those values are substituted into the following equation (2) to determine an impurity concentration (molar fraction) X₂.
X₂={(T₁*−T_{f})·Δ_{f}h₁*}/R·(T₁*)² (2)

Here, R is a gas constant, and Δ_{f}h₁* is a molar melting enthalpy of a pure component at T₁* and a reliable literal value thereof is used. Attention should be paid on an error when a measured value is used.

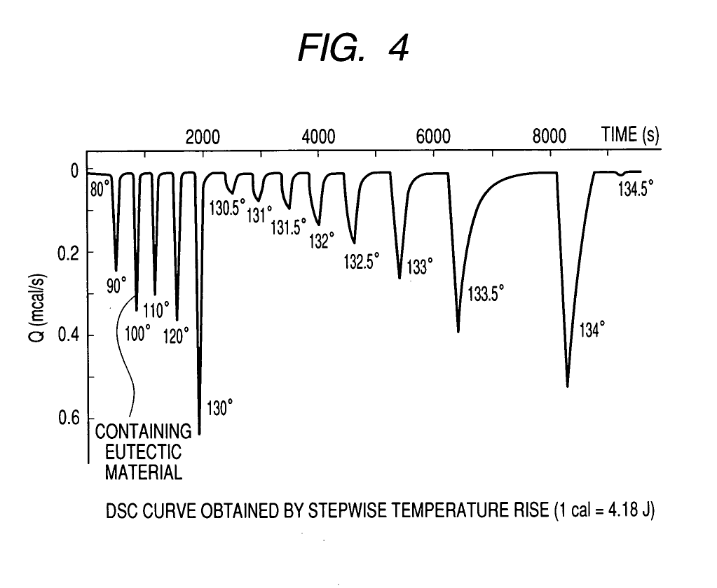

Next, the stepwise temperature rise method will be described with reference to FIG. 4. FIG. 4 is an explanatory graph showing a DSC curve obtained by stepwise temperature rise.

Sample Preparation

Sample preparation is performed in the same manner as in the dynamic method.

Measurement

A relationship between the temperature Ts in an equilibrium state and the melting ratio F is measured by means of stepwise temperature rise. As shown in FIG. 4, the temperature is increased in a stepwise manner. It is confirmed that the DSC curve returns to the isothermal base line after the completion of the first-stage heating, and is stabilized to be in an equilibrium state. Then, the next-stage heating is performed. A value obtained by multiplying the area surrounded by the isothermal base line and the DSC curve by a proportionality factor K corresponds to an enthalpy necessary for heating of one stage. The sum of such enthalpies up to a certain temperature from a lower temperature corresponds to an enthalpy necessary for heating up to the certain temperature. In a temperature region where no melting occurs, the relationship is represented in the form of a straight line because only a specific heat capacity contributes to the relationship. A difference between the straight line obtained by extrapolating the above straight line to the higher temperature side and the enthalpy at a certain temperature corresponds to the melting ratio at the certain temperature. The melting is completed after heating of 10 and several stages and a specific heat capacity portion at the high temperature side is obtained. A temperature difference between stages is set to become large at a low-temperature melting portion in such a manner that the melting fraction is divided into stages having sizes substantially equal to each other.

Analysis

The relationship between the reciprocal of the melting ratio and the temperature is determined. The molar fraction is determined in the same manner as in the above (7) in the dynamic method. In the stepwise temperature rise method, a linear relationship is easily obtained as compared to the dynamic method.

A conventionally known method can be used as a method of obtaining a high-purity organic compound without any particular limitation. Examples of such a method include a sublimation purification method, a recrystallization method, a reprecipitation method, a zone melting method, a column purification method, and an adsorption method. Of those, it is advantageous to adopt the sublimation purification method. In the sublimation purification method, not only a compound which can sublime but also a compound which does not sublime but melts, can be used. That is, distillation can be performed by using a sublimation purification apparatus.

Next, the present invention will be described in more detail by way of the following Examples. However, the present invention is not limited to these Examples.

Sublimation Purification

(1) Dopant material

0.7 g of powder of an organic compound A having the following structure was subjected to sublimation purification at a sublimation point temperature of 250° C. and under a pressure of 2.4×10⁻³ Pa (1.8×10⁵ Torr) to obtain 0.60 g of purified powder of the compound A.

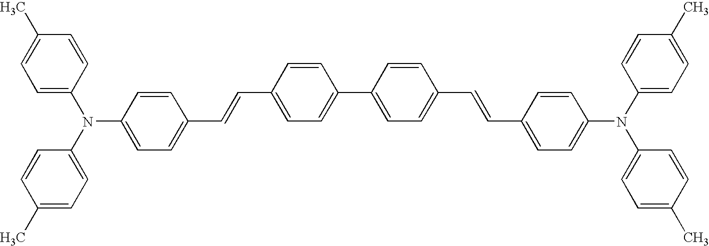

1.1 g of powder of an organic compound A′ having the following structure were subjected to sublimation purification at a sublimation point temperature of 210° C. and under a pressure of 2.4×10⁻³ Pa (1.8×10⁻⁵ Torr) to obtain 0.8 g of purified powder of the compound A′. 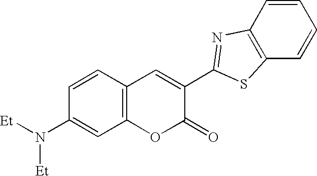
(2) Host Material

2.2 g of powder of an organic compound B having the following structure were subjected to sublimation purification at a sublimation point temperature of 270° C. and under a pressure of 1.3×10⁻³ Pa (1×10⁻⁵ Torr) to obtain 1.9 g of purified powder of the compound B. 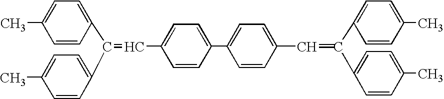
(3) Electron-Transporting Material

8.5 g of powder of an organic compound C having the following structure were subjected to sublimation purification at a sublimation point temperature of 415° C. and under a pressure of 2.4×10⁻³ Pa (1.8×10⁻⁵ Torr) to obtain 6.3 g of purified powder of the compound C. The compound was used as a host material in Example 2. 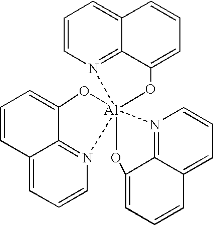
(4) Hole-Transporting Material

20 g of powder of an organic compound D having the following structure were subjected to sublimation purification at a sublimation point temperature of 330° C. and under a pressure of 2.8×10⁻³ Pa (2.1×0-5 Torr) to obtain 17 g of purified powder of the compound D. 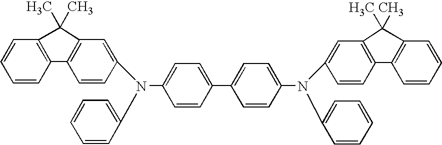
Purity Analysis

Purities of the organic compounds A, B, C, and D before and after the sublimation purification were measured according to the DSC method and the HPLC method. Table 1 below shows the measurements.

TABLE 1
Purities of respective organic compounds before and
after sublimation purification (mol %)

| | DSC method (stepwise | | | |
|---|---|---|---|---|
| | temperature rise | | | |
| | method) | | HPLC method | |
| | Before | After | Before | After |
| | sublima- | sublima- | sublima- | sublima- |
| | tion | tion | tion | tion |
| | purifi- | purifi- | purifi- | purifi- |
| | cation | cation | cation | cation |
| Dopant | 98.32 | 99.91 | 99.2 | 99.3 |
| material | | | | |
| compound A | | | | |
| Dopant | 96.52 | 99.90 | 98.3 | 98.2 |
| material | | | | |
| compound | | | | |
| A′ | | | | |
| Host | 97.03 | 99.92 | 99.6 | 99.6 |
| material | | | | |
| compound B | | | | |
| Electron- | 98.79 | 99.93 | 99.1 | 99.2 |
| transporting | | | | |
| material | | | | |
| compound C | | | | |
| Hole- | 97.93 | 99.99 | 98.0 | 97.9 |
| transporting | | | | |
| material | | | | |
| compound D | | | | |

### Example 1

The organic light-emitting device shown in FIG. 1 was formed as described below.

A film of indium tin oxide (ITO) as an anode 2 was formed to have a thickness of 120 nm on a glass substrate 1 by means of sputtering. The substrate with the film was subjected to ultrasonic cleaning with acetone and isopropyl alcohol (IPA) sequentially. Then, the substrate with the film was subjected to boiling and cleaning with IPA and dried. After that, the substrate with the film was subjected to UV/ozone cleaning, and was used as a transparent conductive support substrate.

A solution having a concentration of 0.1 wt % of the organic compound D that had not been subjected to sublimation purification was dropped onto the ITO electrode. Then, the dropped solution was subjected to spin coating at 500 RPM for 10 seconds and then at 1,000 RPM for 1 minute to form a film. After that, the film was dried in a vacuum oven at 80° C. for 10 minutes to completely remove the solvent in the thin film. The formed hole-transporting layer 4 had a thickness of 50 nm.

Next, the organic compound B that had been subjected to sublimation purification as a host material of the organic luminescent layer 5 and the organic compound A that had been subjected to sublimation purification as a dopant were co-deposited onto the hole-transporting layer 4 to form the organic luminescent layer 5 having a thickness of 20 nm. The co-deposition was performed while the film forming rate was adjusted to 3 nm/sec for the host material and to 0.15 nm/sec for the dopant material.

Furthermore, the organic compound C that had not been subjected to sublimation purification was formed into a film having a thickness of 40 nm as the electron-transporting layer 6 according to a vacuum deposition method. At the time of deposition, the degree of vacuum was 4.0×10⁻⁴ Pa and the film forming rate was 0.3 nm/sec.

Next, a metal film having a thickness of 10 nm was formed on the electron-transporting layer 6 by using a deposition material made of an aluminum-lithium alloy (having a lithium concentration of 1 atomic %) according to the vacuum deposition method. Furthermore, an aluminum film having a thickness of 150 nm was formed according to the vacuum deposition method to produce an organic light-emitting device having the aluminum-lithium alloy film as the electron-injecting electrode (cathode 7). At the time of deposition, the degree of vacuum was 4.0×10⁻⁴ Pa and the film forming rate was in the range of 1.0 to 1.2 nm/sec.

The organic light-emitting device thus obtained was covered with a cover glass plate (the casing 8) and sealed with an acrylic resin-based adhesive in a dry air atmosphere in order to avoid device deterioration due to adsorption of moisture.

The obtained organic light-emitting device had an emission chromaticity of blue (0.15, 0.21) and a luminance of 150 cd/m² at 4.3 V and 300 cd/m² at 4.5 V.

In addition, when a voltage was applied for 50 hours in a nitrogen atmosphere while a current density was kept at 30 mA/cm², the luminance after 50 hours of voltage application was 75% of the initial luminance of 1,500 cd/m² and therefore luminance deterioration was small.

### Example 2

An organic light-emitting device was produced in the same manner as in Example 1 except the following points. First, the hole-transporting layer 4 was formed by using the organic compound D that had been subjected to sublimation purification. Second, the organic compound C that had been subjected to sublimation purification as the host material of the organic luminescent layer 5 and the organic compound A′ that had been subjected to sublimation purification as the dopant material were co-deposited (the film forming rate at the time of co-deposition was adjusted to 0.5 nm/sec for the host material and to 0.1 nm/sec for the dopant material). Third, the electron-transporting layer 6 was formed by using the organic compound C that had been subjected to sublimation purification.

The obtained organic light-emitting device had an emission chromaticity of green (0.28, 0.63) and a luminance of 150 cd/m² at 3.7 V and 300 cd/m² at 4.0 V.

In addition, when a voltage was applied for 100 hours in a nitrogen atmosphere while a current density was kept at 30 mA/cm², the luminance after 100 hours of voltage application was 90% of the initial luminance of 1,800 cd/m² and therefore luminance deterioration was small.

### Comparative Example 1

An organic light-emitting device was produced in the same manner as in Example 1 except that the organic compounds D, B, A, and C that had not been subjected to sublimation purification were used as the hole-transporting material, the dopant material, the host material, and the electron-transporting material. Then, the organic light-emitting device was evaluated in the same manner as in Example 1.

The obtained organic light-emitting device had an emission chromaticity of blue (0.14, 0.21) and a luminance of 150 cd/m² at 4.2 V and 300 cd/m² at 4.5 V. That is, results similar to those of Example 1 were obtained.

However, when a voltage was applied for 50 hours in a nitrogen atmosphere while a current density was kept at 30 mA/cm², the luminance after 50 hours of voltage application was 50% of the initial luminance of 1,500 cd/m² and therefore luminance deterioration was large.

### Comparative Example 2

An organic light-emitting device was produced in the same manner as in Example 2 except that the organic compounds D, C, and A′ that had not been subjected to sublimation purification were used as the hole-transporting material, the dopant material, the host material, and the electron-transporting material. Then, the organic light-emitting device was evaluated in the same manner as in Example 2.

The obtained organic light-emitting device had an emission chromaticity of green (0.28, 0.63) and a luminance of 150 cd/m² at 3.6 V and 300 cd/m² at 4.0 V. That is, results similar to those of Example 2 were obtained.

However, when a voltage was applied for 100 hours in a nitrogen atmosphere while a current density was kept at 30 mA/cm², the luminance after 100 hours of voltage application was 75% of the initial luminance of 1,800 cd/m² and therefore luminance deterioration was large.

As described above, the organic light-emitting device of the present invention that has been described by way of the embodiment and the examples shows no attenuation of emission luminance even when driven for a long period of time and is excellent in durability. Therefore, the organic light-emitting device of the present invention can be suitably used in, for example, a display of an information device.

This application claims priority from Japanese Patent Application No. 2003-416160 filed Dec. 15, 2003, which is hereby incorporated by reference herein.

1. An organic light-emitting device comprising an organic compound layer having at least an organic luminescent layer, the organic compound layer being sandwiched between a pair of electrodes composed of an anode and a cathode, wherein at least one of the organic compounds used for forming the organic compound layer comprises an organic compound having a purity of 99 mol % or more in analysis according to a differential scanning calorimetry method.

2. An organic light-emitting device according to claim 1, wherein the organic compound having a purity of 99 mol % or more is purified by means of a sublimation purification method.

3. An organic light-emitting device according to claim 1, wherein respective layers of the organic compounds constituting the organic compound layer are formed using the organic compounds constituting the respective layers by means of a physical vapor deposition method.
